(19) United States
(12) Patent Application Publication
(10) Pub. No.: US 2008/0226384 A1
(43) Pub. Date: Sep. 18, 2008

(54) Binder With Front Flap

(75) Inventor: Tai Woon Shing, Hong Kong (HK)

Correspondence Address: BOND, SCHOENECK & KING, PLLC, ONE LINCOLN CENTER, SYRACUSE, NY, 13202-1355, US

(73) Assignee: MeadWestvaco Corporation, Glen Allen, VA (US)

(21) Appl. No.: 11/775,527

(22) Filed: Jul. 10, 2007

Related U.S. Application Data
(63) Continuation-in-part of application No. 29/277,891, filed on Mar. 13, 2007, now abandoned.

(51) Int. Cl. B42F 13/00

(52) U.S. Cl. 402/73

(57) ABSTRACT

An organizer product comprising front and rear covers each having inwardly and outwardly facing surfaces and being joined to define an open space therebetween; a recess formed in the outwardly facing surface of the front cover; and a recess cover mounted to the front cover for movement between covering and non-covering relation relative to the recess.

### CLAIM OF PRIORITY

The present application is a continuation-in-part of and claims priority to Applicant's co-pending U.S. Design patent application Ser. No. 29/277,891, the entirety of which is hereby incorporated by reference.

### BACKGROUND OF THE INVENTION

The present invention relates generally to organizer type products, and more specifically to a zippered ring binder having an exterior window in which items can be stored and viewed.

Personal and professional organizers and planners typically comprise a variety of information recording pages stored in a binder or other containment device. The types of pages included in these products include, for example, calendars and agenda pages (e.g., daily, weekly, monthly sheets), to do list pages, shopping list pages, telephone directories, and the like, all of which is well understood in the art. Throughout the period of time for which the planner/organizer is intended to be used, the binder often becomes bulky and inundated with several loose sheets of paper. When the binder becomes encumbered with vast amounts of information, quickly finding an item of interest becomes more difficult. For instance, turning quickly to a daily agenda may take more time than desired, or locating directions to a destination written on a memo pad may not be able to be retrieved too quickly.

To provide for quicker retrieval of information, most binders/organizers include tabs and/or “bookmarks” that permit the desired pages to be located without having to flip through the many pages. However, even tabbed or marked pages can take time to locate. Furthermore, when the binder is enclosed with a clasp, zipper, or other conventional fastening means, having to open, locate, and then close the binder may take more time than desired to locate the information.

It is therefore a principal object and advantage of the present invention to provide an organizer binder that facilitates quick retrieval of desired information.

It is another object and advantage of the present invention to provide an organizer binder that maintains a conventional profile while improving upon conventional like products in its ability to provide quick retrieval/review of desired information.

It is a further object and advantage of the present invention to provide an organizer binder that provides for secure storage of information recorded on the pages stored in the binder.

Other objects and advantages of the present invention will in part be obvious, and in part appear hereinafter.

### SUMMARY OF THE INVENTION

In accordance with the foregoing objects and advantages, the present invention provides an organizer product, comprising front and rear covers each having inwardly and outwardly facing surfaces and being joined to define an open space therebetween; a recess formed in the outwardly facing surface of the front cover; and a recess cover mounted to the front cover for movement between covering and non-covering relation relative to the recess. The first and rear covers are joined along a binding, and collectively define an enclosed space in which informational pages may be stored. The enclosed space in accessible by a closing means, preferably a zipper that extends along the top, bottom, and front edges of the front and rear covers, though other conventional fastening means could be used (e.g., clasp, buckles, magnetic closure, VELCRO® fasteners, and the like all of which are well known to those of ordinary skill in the art).

The recess cover (or door/flap) is mounted to the front cover and is movable between covered and uncovered relation to the recess. In its neutral state, the recess cover is positioned in covering relation to the recess. The recess cover is preferably non-transparent so as to provide a level of privacy/security to the contents/information contained on the memo pad positioned within the recess such that it is not open for viewing absent manually moving the recess cover away from the recess.

### BRIEF DESCRIPTION OF THE DRAWINGS

The present invention will be more fully understood and appreciated by reading the following Detailed Description in conjunction with the accompanying drawings, in which:

FIG. 1 is a perspective view of a binder having a flap formed on the front surface of the binder;

FIG. 2 is a front elevation view thereof;

FIG. 3 is a right side elevation view thereof;

FIG. 4 is a left side elevation view thereof;

FIG. 5 is top plan view thereof;

FIG. 6 is a bottom plan view thereof;

FIG. 7 is a rear elevation view thereof;

FIG. 8 is a perspective view of thereof with the front flap formed on the front surface shown in its open position;

FIG. 9 is a top plan view of the binder with the flap in its open position and the memo pad removed from the recess; and

FIG. 10 is a top plan view of the binder with the flap in its open position and the memo pad positioned within the recess.

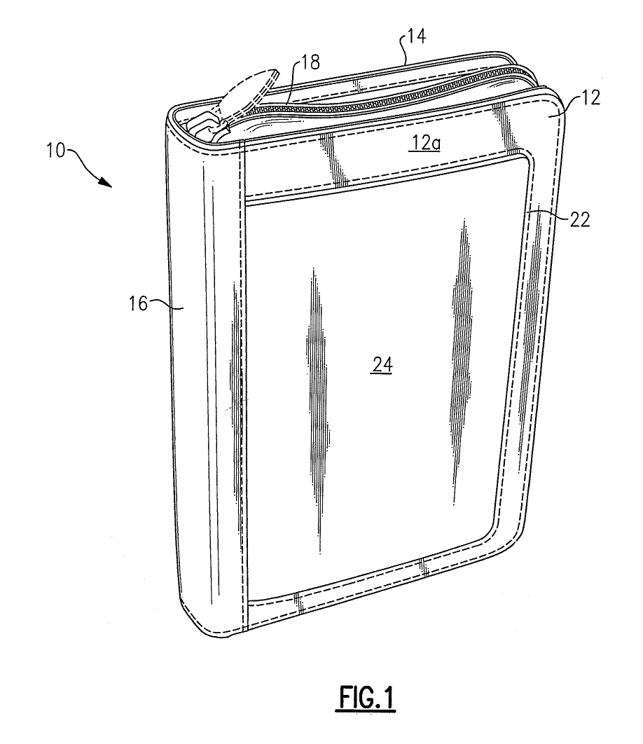

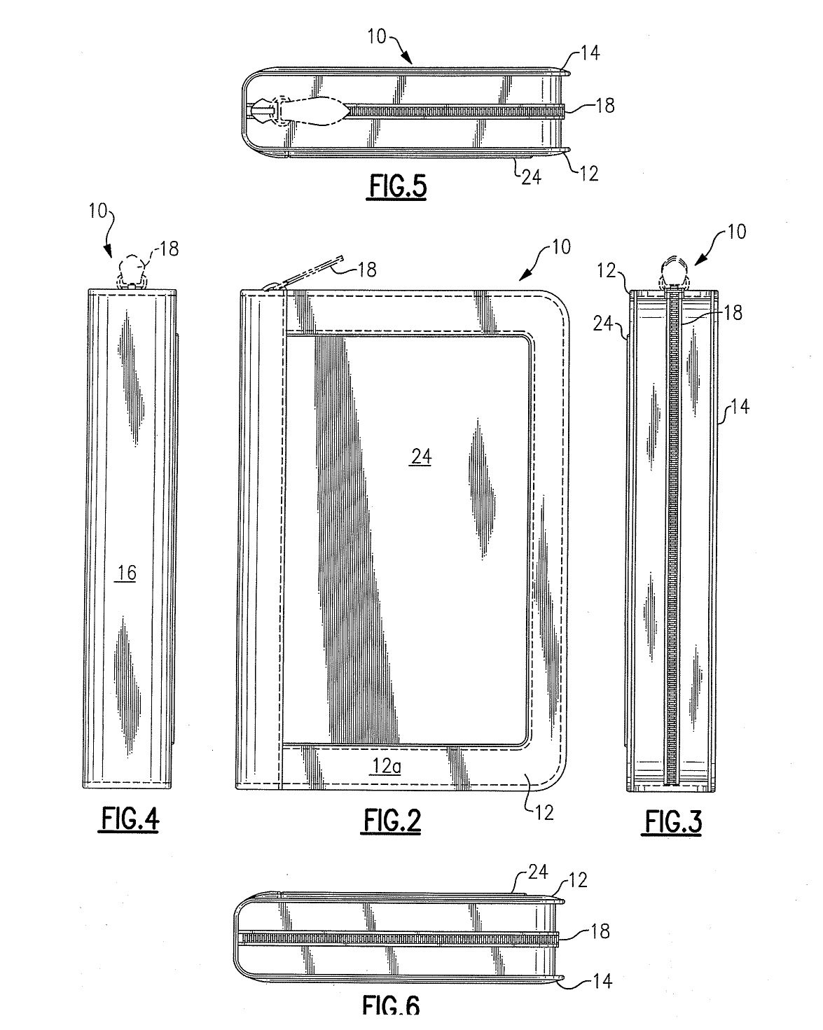

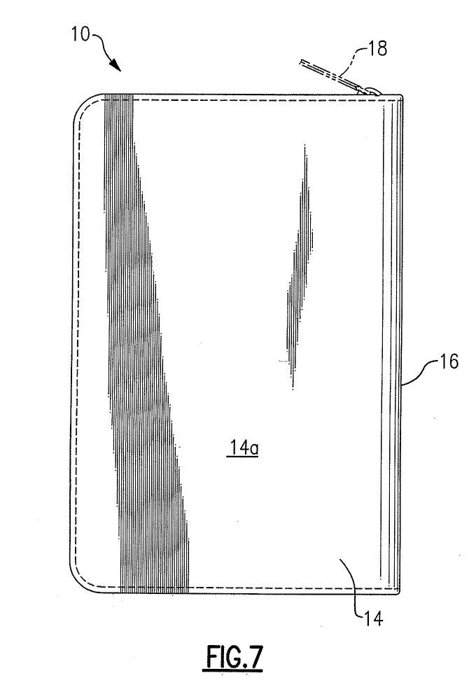

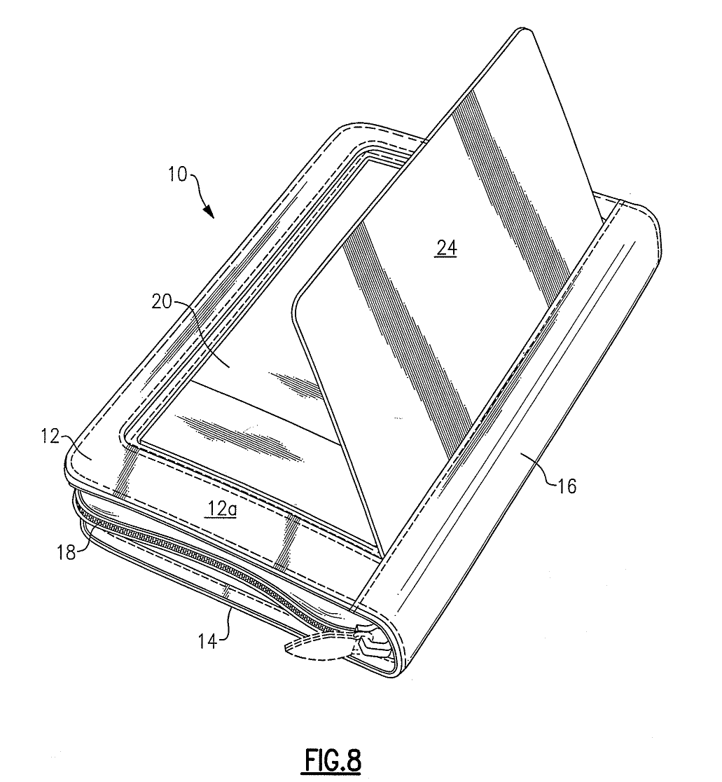

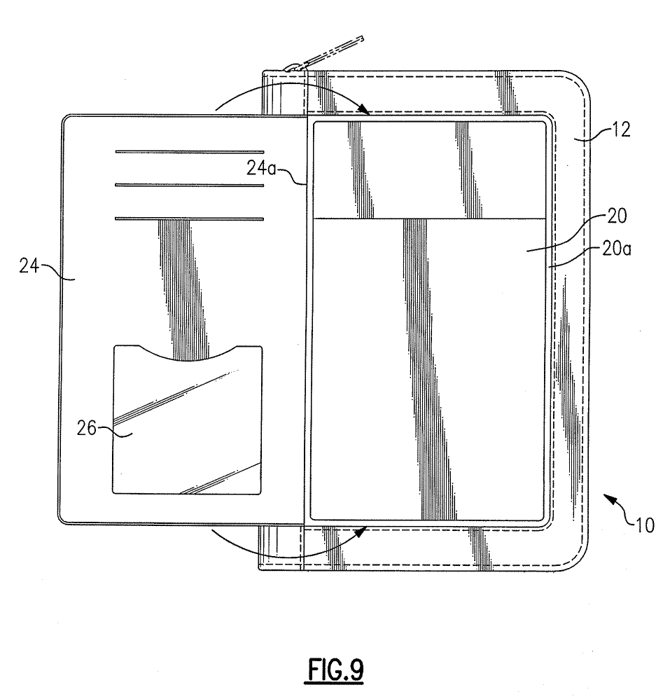

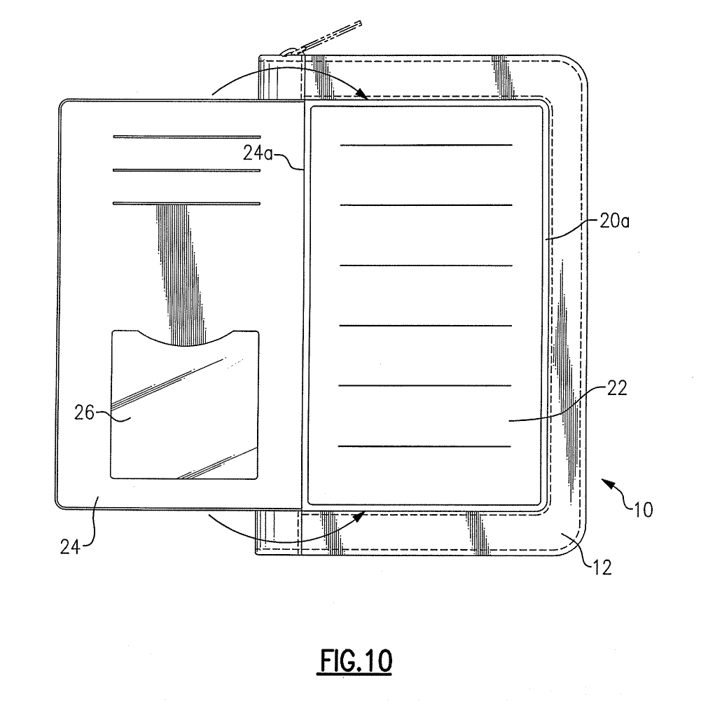

### DETAILED DESCRIPTION

Referring now to the drawings, in which like reference numerals refer to like parts throughout, there is seen an organizer binder, designated generally by reference numeral 10, comprising front and rear covers 12 and 14, respectively, that are joined along a binding/spine 16. A zipper 18 provides a closure means for closing and opening first and rear covers 12, 14 relative to one another. It is understood by those of ordinary skill in the art that other conventional closure means, such as buckles, clasps, VELCRO® fasteners, magnetic closures, and the like could be substituted for zipper 18.

Front cover 12 includes outwardly and inwardly facing surfaces 12a, 12b, respectively (and rear cover includes corresponding inwardly and outwardly facing surfaces), and a recess 20 is formed in outwardly facing surface 12a. A flange 20a is formed about and defines the periphery of recess 20. In addition, a pocket 20b is formed in recess 20a to permit the secure, but removable placement of a memo pad 22 therein (with memo pad 24 preferably lying in a plane that extends no more than co-planar with flange 20a for reasons that will be apparent hereinafter).

A recess cover (or door/flap) 24 is also affixed along one of its side edges 24a to front cover 12 and, more precisely, along one edge of recess 20. Recess cover 24 is adapted for movement between covered and uncovered relation relative to recess 20 (and memo pad 22 stored therein), and is preferably in complete covering relation when in its neutral condition (i.e., absent any external force being applied, recess cover 24 will come to rest in covered relation to recess 20/memo pad 22). Recess cover 24 preferably lies in contacting relation to flange 20a when in its covered relation to recess 20. As one of its purposes is to conceal memo pad 22 (and any information contained on the memo pad 22), recess cover 24 is of about the same dimensions as recess 20 and is composed of non-transparent material, and may for aesthetic reasons be of the same material and pattern as the remainder of outwardly facing surface 12a. Recess cover 24 also includes an inwardly facing surface in which are formed a compartment 26 and slots 28 in which content, such as business cards, may be stored.

To ensure closure of recess cover 24 relative to recess 20, a ferrous material may be embedded in front cover 12, preferably in flange 20a, and magnet(s) may be embedded in recess cover 24 (or vice-versa) such that the magnetic force pulls recess cover 24 into closed relation to recess 20 absent an external force being applied to overcome the magnetic force. By lifting recess cover 24 away from recess 20, the user can quickly and easily view whatever information is contained on memo pad 22, or can access memo pad 22 to write something thereon, or can access whatever content is contained in compartment 26 formed on the inwardly facing surface of recess cover 24. It is understood by those of ordinary skill in the art that other types of closure mechanisms could be employed as well, such as snaps or clips.

To maintain a relatively thin profile for organizer binder 10 (or at least a profile that is not significantly thicker than a conventional organizer without a recess and recess cover as provided for with the present invention), recess cover 24 is adapted to sit within recess 20 and on flange 20a such that its outwardly facing surface is about co-planar with exterior surface 12a of front cover 12; recess cover 24 may extend a slight distance above exterior surface 12a to permit a user's finger to access and pull outwardly on recess cover 24, but the distance is not significant to affect the aesthetics or profile of the organizer binder 10.

Organizer binder 10 includes conventional rings 26 affixed within the interior thereof along binding 16, which are adapted to retain pages, such as calendar pages, agenda pages, to do list pages, telephone directory pages, shopping list pages, any combination of the foregoing, and any other pages common to planners and organizer products, all of which are known to those of ordinary skill in the art.

What is claimed is:

1. An organizer product, comprising:
a. front and rear covers each having inwardly and outwardly facing surfaces and being operatively joined to define an open space therebetween;
b. a recess formed in the outwardly facing surface of said front cover; and
c. a recess cover mounted to said front cover for movement between complete covering and non-covering relation relative to said recess.

2. The organizer product of claim 1, further comprising means for enclosing said open space defined between said front and rear covers.

3. The organizer product of claim 2, wherein said enclosing means comprises a zipper.

4. The organizer product of claim 3, wherein said front and rear covers are joined to one another along a binding, and each further comprises top, bottom, and front edges and said zipper extends along each of said front and rear covers' top, bottom, and front edges.

5. The organizer product of claim 1, further comprising a memo pad removably positioned within said recess.

6. The organizer product of claim 1, further comprising a plurality of binder rings positioned within said open space defined between said front and rear covers.

7. The organizer product of claim 1, wherein said recess cover includes one of a magnet or a ferrous material embedded therein and said front cover includes the other of said magnet or ferrous material embedded therein.

8. The organizer product of claim 1, wherein said recess cover includes an inwardly facing surface and at least one compartment is formed on said recess cover's inwardly facing surface.

9. An organizer product, comprising:
a. front and rear covers each having inwardly and outwardly facing surfaces and being operatively joined to define an open space therebetween;
b. a recess formed in the outwardly facing surface of said front cover; and
c. a recess cover mounted to said front cover for movement between covering and non-covering relation relative to said recess, wherein said recess cover extends essentially co-planar with said outwardly facing surface of said front cover when in said covering relation.

10. The organizer product of claim 9, further comprising means for enclosing said open space defined between said front and rear covers.

11. The organizer product of claim 10, wherein said enclosing means comprises a zipper.

12. The organizer product of claim 11, wherein said front and rear covers are joined to one another along a binding, and each further comprises top, bottom, and front edges and said zipper extends along each of said front and rear covers' top, bottom, and front edges.

13. The organizer product of claim 9, further comprising a memo pad removably positioned within said recess.

14. The organizer product of claim 9, further comprising a plurality of binder rings positioned within said open space defined between said front and rear covers.

15. The organizer product of claim 9, wherein said recess cover includes one of a magnet or a ferrous material embedded therein and said front cover includes the other of said magnet or ferrous material embedded therein.

16. The organizer product of claim 9, wherein said recess cover includes an inwardly facing surface and at least one compartment is formed on said recess cover's inwardly facing surface.

17. The organizer product of claim 9, wherein said recess cover completely covers said recess when in covering relation thereto.
